(19) United States
(12) Patent Application Publication
(10) Pub. No.: US 2011/0214166 A1
(43) Pub. Date: Sep. 1, 2011

(54) CONNECTION MANAGEMENT

(75) Inventor: Preetida Vinayakray-Jani, Ahmedabad (IN)

(73) Assignee: NOKIA CORPORATION, Espoo (FI)

(21) Appl. No.: 13/127,024

(22) PCT Filed: Oct. 29, 2008
(86) PCT No.: PCT/FI08/50612

§ 371 Date: Apr. 29, 2011

(51) Int. Cl. H04L 9/32; G06F 21/00

(52) U.S. Cl. 726/5

(57) ABSTRACT

At a mobile internet protocol (MIP) enabled mobile node (MN), an internet key exchange (IKE) security association (SA) message is prepared and an extension is contained in the SA message indicative of an MIP binding related instruction to a home agent (HA). The SA message is then sent to a packet data network. At a network element, the SA message and an IKE SA message are received from the mobile node. The network element determines in the SA message an MIP binding related instruction to the HA and stores an MIP message based on the determined MIP related instruction. The network element also sends the MIP message to the HA of the MN.

### FIELD OF THE INVENTION

The present invention generally relates to connection management. The invention relates particularly, though not exclusively, to connection management in mobile internet.

### BACKGROUND OF THE INVENTION

The Internet was originally designed for use in fixed networks. In order to provide for mobile access to the internet, mobile internet protocol (MIP) was developed. In a modern version MIP version 6 (MIP6), home agents (HA) maintain a care of address for moving IP clients which connect through arbitrary foreign agents (FA). In order to subscribe to a HA, a client generally referred to as a mobile node (MN) has to authenticate itself to the HA. The authentication of the MN to the HA involves establishing a security association (SA) using internet key exchange (IKE) version 2 messages (IKEv2) and then on top of an established SA, MIP specific messages are exchanged between the MN and the HA in order to bind an MN to its HA. Moreover, when a MN roams from one access network to another, the SA is likely to change. A new SA is then formed and then an MIP binding is updated.

In MIP, the lifetime associated with IKE exchanges (i.e. related to the SA) may expire before that of an MIP binding defined in a binding update (BU) message. In consequence, when the MN moves to the home network, it is very likely that de-registration of the BU cannot be securely delivered from the MN to the HA. Hence, the HA falsely expects the MN to still be connected and maintains the connection and associated charging (if applied) until the MIP binding expires or the HA notices a loss of connection (e.g. if keep-alive messages are sent from the HA to the MN to monitor the presence of the MN).

Generally, it is seen that in MIP, an IKE negotiation is triggered by network. Then, an end-to-end connectivity establishment follows i.e. a MIP signaling exchange is conducted between the MN and the HA.

### SUMMARY

According to a first example aspect of the invention there is provided a method comprising:
preparing an internet key exchange security association message;
containing in the security association message an extension indicative of a mobile internet protocol binding related instruction to a home agent; and
sending the security association message to a packet data network.

According to a second example aspect of the invention there is provided a method comprising:
receiving from a mobile internet protocol mobile node an internet key exchange security association message;
determining in the security association message a mobile internet protocol binding related instruction to a home agent of the mobile node;
storing a mobile internet protocol message based on the determined mobile internet protocol related instruction; and
sending the mobile internet protocol message to the home agent of the mobile node.

According to a third example aspect of the invention there is provided an apparatus comprising a memory configured to store instructions and a processor configured to perform according to the instructions:
preparing an internet key exchange security association message;
containing in the security association message an extension indicative of a mobile internet protocol binding related instruction to a home agent; and
sending the security association message to a packet data network.

According to a fourth example aspect of the invention there is provided an apparatus comprising a memory configured to store instructions and a processor configured to perform according to the instructions:
receiving from a mobile internet protocol mobile node an internet key exchange security association message;
determining in the security association message a mobile internet protocol binding related instruction to a home agent of the mobile node;
storing a mobile internet protocol message based on the determined mobile internet protocol related instruction; and
sending the mobile internet protocol message to the home agent of the mobile node.

According to a fifth example aspect of the invention there is provided a computer program comprising computer executable program code for causing an apparatus when processing the program code to:
prepare an internet key exchange security association message;
contain in the security association message an extension indicative of a mobile internet protocol binding related instruction to a home agent; and
send the security association message to a packet data network.

According to a sixth example aspect of the invention there is provided a computer program comprising computer executable program code for causing an apparatus when processing the program code to:
receive from a mobile internet protocol mobile node an internet key exchange security association message;
determine the security association message a mobile internet protocol binding related instruction to a home agent of the mobile node;
store a mobile internet protocol message based on the determined mobile internet protocol related instruction; and
send the mobile internet protocol message to the home agent of the mobile node.

According to a seventh example aspect of the invention there is provided a computer readable memory medium comprising computer executable program code for causing an apparatus when processing the program code to:
prepare an internet key exchange security association message;
contain in the security association message an extension indicative of a mobile internet protocol binding related instruction to a home agent; and
send the security association message to a packet data network.

According to an eighth example aspect of the invention there is provided a computer readable memory medium comprising computer executable program code for causing an apparatus when processing the program code to:
receive from a mobile internet protocol mobile node an internet key exchange security association message;
determine the security association message a mobile internet protocol binding related instruction to a home agent of the mobile node;
store a mobile internet protocol message based on the determined mobile internet protocol related instruction; and
send the mobile internet protocol message to the home agent of the mobile node.

The apparatus may be, for example, a mobile node, a data communication network server, a chip for controlling an electronic apparatus or a sub-assembly for controlling an electronic apparatus.

According to a ninth example aspect of the invention there is provided an apparatus comprising:
means for preparing an internet key exchange security association message;
means for containing in the security association message an extension indicative of a mobile internet protocol binding related instruction to a home agent; and
means for sending the security association message to a packet data network.

According to a tenth example aspect of the invention there is provided an apparatus comprising:
means for receiving from a mobile internet protocol mobile node an internet key exchange security association message;
means for determining in the security association message a mobile internet protocol binding related instruction to a home agent of the mobile node;
means for storing a mobile internet protocol message based on the determined mobile internet protocol related instruction; and
means for sending the mobile internet protocol message to the home agent of the mobile node.

Any foregoing memory medium may be a digital data storage such as a data disc or diskette, optical storage, magnetic storage, holographic storage, phase-change storage (PCM) or opto-magnetic storage. The memory medium may be formed into a device without other substantial functions than storing memory or it may be formed as part of a device with other functions, including but not limited to a memory of a computer, a chip set, and a sub assembly of an electronic device.

Different non-binding example aspects and example embodiments of the present invention have been illustrated in the foregoing. Some embodiments may be presented only with reference to certain example aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a schematic picture of a system according to an example embodiment of the invention;

FIG. 2 shows a block diagram of a computer apparatus configured to operate as a mobile node or as another entity that may implement an embodiment of the invention;

FIG. 3 shows a flow chart describing an example process to establish a security association (SA) according to Internet Key Exchange (IKE) v2 as part of Mobile Internet Protocol (MIP);

FIG. 4 illustrates a process for generating the second security association according to an embodiment of the invention; and

FIG. 5 shows an example of an IKEv2 exchange that may be used in the process of FIG. 4

### DETAILED DESCRIPTION

In the following detailed description of example embodiments of the invention, reference is made to the accompanied drawings. The drawings illustrate specific example embodiments according to which some embodiments of the invention be practiced. It shall be appreciated that other embodiments may be utilized and other changes be made without departing from the spirit or scope of the present invention. The following detailed description is, therefore, not to be taken in a limiting sense, and the scope of the present invention is to be defined only by the patent claims.

In this application, like numbers denote like elements of the drawings. Additionally, a reference to the singular includes a reference to the plural unless otherwise stated or is inconsistent with the disclosure herein.

A mobile node (MN) generally refers herein to a network element that is configured operable in mobile internet protocol (MIP) networks in conjunction with a foreign agent and a home agent. A foreign agent is generally an entity that controls one or more access points (AP) in a visited network i.e. generally in any network of one or more APs to which the MN may attach through one or more of the APs. Broadly speaking, even BTSs of cellular networks may be perceived as APs. A home agent (HA), on the other hand, is generally an entity that maintains a care-of address (CoA) in a binding table for the MN and helps the MN to connect to the Internet through a variety of different APs in foreign networks with help of FAs of the foreign networks. In the MIP version 4 (MIPv4), the communications to and from the MN were routed through the HA. On the other hand, the MIP version 6 enables triangular routing in which outgoing packets may be routed directly to their recipients from the MN (or via the HA in particular if necessary, for example due to ingress filtering used by routers in the visited foreign network). A user may refer herein to any person or customer such as a business or organization that employs an MN to communicate or more generally to access resources over or of a mobile network.

The different functional entities in this description may be implemented in numerous different ways known to ordinarily skilled persons. The entities may be provided by means of computer program controlling a processor that somehow controls a generic or dedicated circuitry (e.g. general computer, microprocessor, digital signal processor or application specific integrated circuit). The entities may also or alternatively comprise generic or dedicated circuitry as mentioned in the preceding. In one embodiment, the MN may be realized by means of suitably adapted software controlling the circuitry of a modern mobile phone such as Nokia N95 that has wireless local area networking (WLAN), Bluetooth and various cellular data interfaces such as GSM, PCS, and WCDMA data interfaces.

Generally, the MN may be a wireless device that can change its point of attachment from one network or sub-network to another. The MN may change its location without losing connectivity and without changing its IP address by continuing to communicate with other nodes at any location using its (typically constant) IP address, assuming link-layer connectivity to a point of attachment is available. The MN may change its point of attachment from one link to another, while still being reachable via its constant IP address with help of the HA.

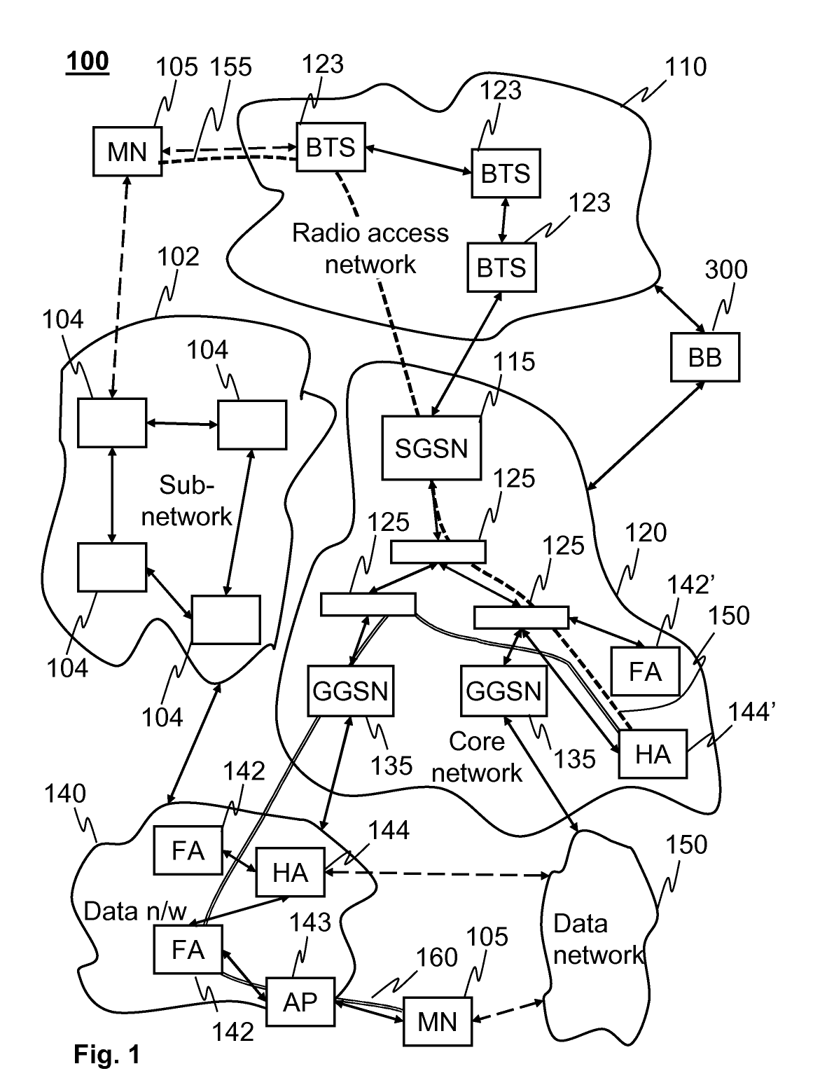

FIG. 1 shows a schematic picture of a system 100 according to an embodiment of the invention. In FIG. 1, there is presented a mobile terminal (MT) or generally speaking a MN 105, radio access network (RAN) 110, a serving gateway support node SGSN 115, a core network 120, base stations 123, routers 125, an optional bandwidth broker (BB) 300, GGSNs 135, a first data network 140 such as the Internet and a second data network 150 such as a corporation network. FIG. 1 also presents a sub-network 102, which comprises a plurality of wireless devices 104 in communication with each other and with the mobile node 105. The sub-network 102 may be based on any wireless communication protocol such as a short range communication protocols including but not limited to the Bluetooth protocol.

Generally, the MN 105 may include any communication device capable of connecting to a wireless network such as radio access network 110. Such communication devices include cellular telephones, smart phones, pagers, radio frequency (RF) devices, infrared (IR) devices, integrated devices combining one or more of the preceding communication devices, and the like. The MN 105 may also include other devices that have a wireless interface such as Personal Digital Assistants (PDAs), handheld computers, personal computers, multiprocessor systems, microprocessor-based or programmable consumer electronics, network PCs, wearable computers, and the like.

The MN 105 is coupled to radio access network (RAN) 110.

The Radio Access Network (RAN) 110 may manage radio resources thereof. The RAN 110 may provide the MN 105 with a mechanism to access a core network 120. The RAN 110 may transport information to and from devices capable of wireless communication, such as the MN 105. The RAN 110 may include both wireless and wired telecommunication components. For example, the RAN 110 may include a cellular base station mast and/or base stations 123 linked to a wired telecommunication network. Typically, the cellular mast carries wireless communication to and from cell phones, pagers, and other wireless devices, and the wired telecommunication network carries communication to regular phones, long-distance communication links, and the like.

Different network entities in the core network 120 may be interconnected with a set of intermediate network elements such as routers 125. Also one or more of the base stations may have router functionality.

Some nodes in the core network may be General Packet Radio Service (GPRS) nodes. For example, a Serving GPRS Support Node (SGSN) 115 may send and receive data from mobile stations, such as the MN 105, over the RAN 110. The SGSN 115 may also maintain location information relating to the MS 105. The SGSN 115 may facilitate communicating of the MN 105 with external data communication networks through the CN 120 and via a Gateway GPRS Support Node (GGSN) 135. According to one embodiment of the invention, a bandwidth broker BB 300 may communicate with the RAN 110 and with the CN 120.

The CN 120 may comprise an IP packet based backbone network that includes routers, such as routers 125, to connect different support nodes in the network.

The first data network 140 may comprise a plurality of different mobile IP (MIP) networks as subnets. Each such MIP subnet may comprise one or more home agents (HA) 144 corresponding to a group of foreign agents (FA) 142 which manage the use of various access points (AP) 143. The concept of MIP is well known, but FIG. 1 presents one MIP subnet in the context of a range of different communications networks such as a cellular RAN, a cellular CN, a peer-to-peer sub-network 102, the Internet and a corporation network. It is appreciated that there may be also further networks and that not all the networks shown in FIG. 1 need to be present for using particular embodiments of the invention. FIG. 1 further illustrates one FA 142′ and HA 144′ in the CN 120. A cellular network operator may provide a MIP platform for home users and foreign users such that each user may access the FA 142′ through the RAN 110 and the CN 120. Further still, a MIP platform may be in part or entirely located into the RAN 110. Still further, the HA 144′ may reside in a different network than the FA 142′. In case of a roaming, foreign MIP user, the home agent HA 142′ of a roaming MN 105 resides in a different network than the visited network and thus the MN 105 attaches to an AP 143 of the visited network, gains access by means of a FA 142′ and maintains its connectivity to the Internet via its HA (not shown) at its home MIP platform.

The media used to transmit information in the communication links as described in this document merely illustrate particular computer-readable media, namely communication media. Generally, the computer-readable media include any medium that can be accessed by a computing device. The communication media typically embody computer-readable instructions, data structures, program modules, or other data in a modulated data signal such as a carrier wave or other transport mechanism and includes any information delivery medium. The term modulated data signal may refer to a signal that has one or more of its characteristics set or changed in such a manner as to encode information in the signal. By way of example, the communication media may include wired media such as twisted pair, coaxial cable, fiber optics, wave guides, and other wired media and wireless media such as acoustic, RF, infrared, and other wireless media.

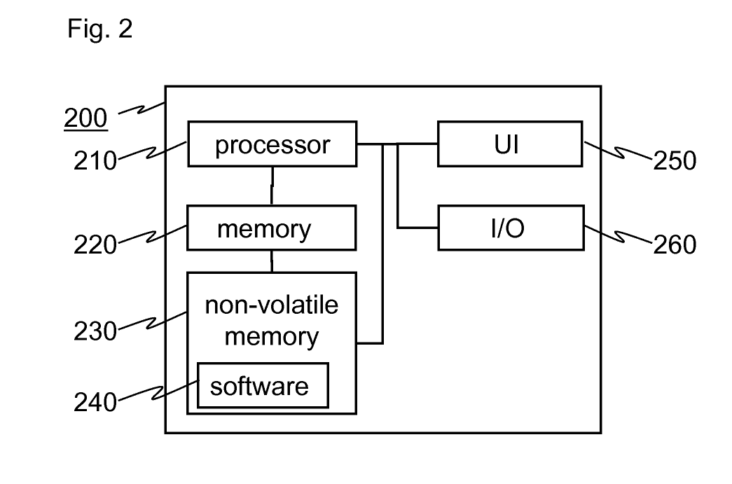

The structure of an example computer suited for use in particular embodiments of the invention is next described with reference to FIG. 2 and then the operation in some embodiments is illustrated with reference to signaling diagrams 3 onwards.

FIG. 2 shows a block diagram of an apparatus 200 (e.g. a computer) configured to operate as an MN 105 or as another entity that may implement an embodiment of the invention. The computer 200 comprises a processor 210, a memory 220 for use by the processor to control the operation of the computer 200, a non-volatile memory 230 for storing long-term data such as software 240 comprising an operating system and computer executable applications, a user interface 250 for user interaction such as voice input and/or output, and an input/output system 260 for communication with other entities in a packet data network (PDN).

The processor 210 may be a master control unit MCU. Alternatively, the processor may be a microprocessor, a digital signal processor, an application specific integrated circuit, a field programmable gate array, a microcontroller or a combination of such elements.

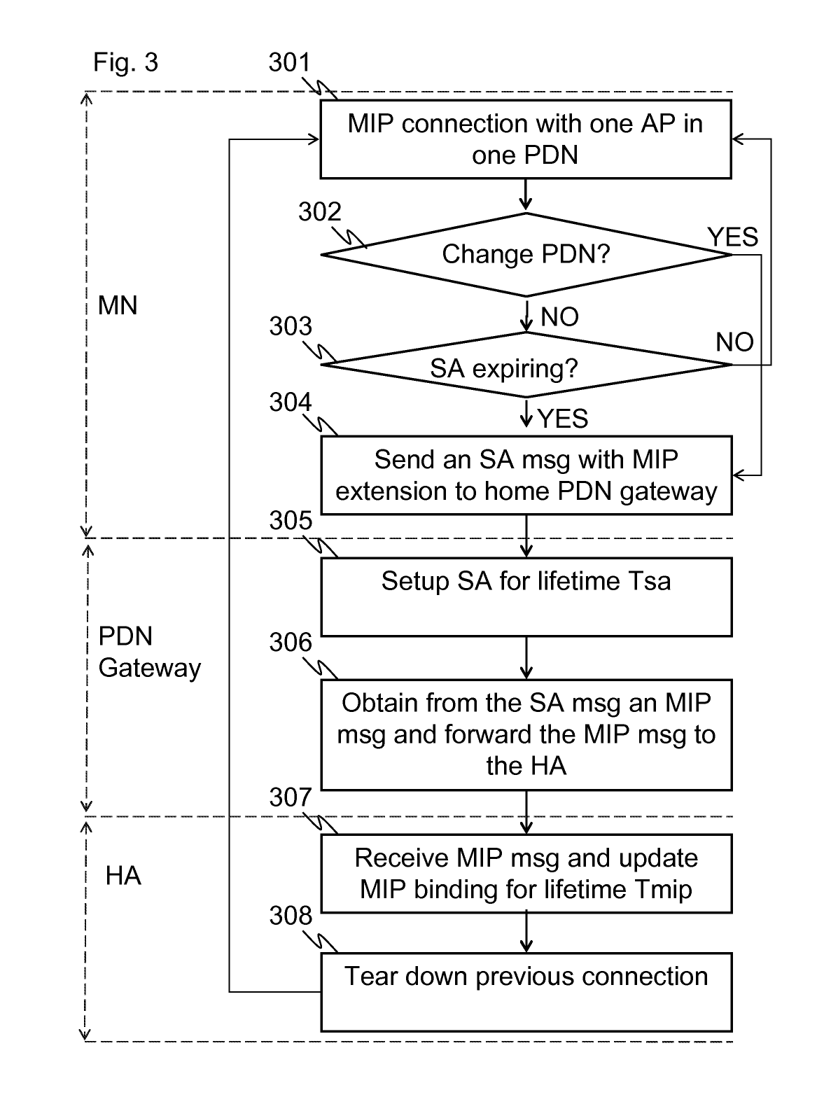

FIG. 3 shows a flow chart describing an example process to establish a security association (SA) between two nodes in a packet switched data communication network according to IKEv2 as part of mobile IP.

In step 301, the MN 105 is connected to the home agent 144 that is operated by a cellular operator in the network of whose the MN 105 resides. The HA may be a separate network entity routably accessible in the CN 120 or integrated to a GGSN 135. Next, the MN 105 checks 302 whether a change in the PDN with which it communicates has taken place. Namely, when armed with an effective movement detection algorithm, the MN may detect a potential new PDN.

If yes, the process advances to step 304, otherwise the MN checks 303 whether its SA used for exchanging MIP messages with the HA is expiring (or has expired). If the SA is still usable for at least a given time, the process resumes to step 301.

In step 304, the MN 105 prepares an SA establishment message with an MIP extension for a home PDN gateway (or for the HA, if the SA is formed at the HA). In an example embodiment, the MN 105 includes in an internet key exchange (IKE) version 2 (aka IKEv2) a field. Thus formed an SA message may be basically an SA message that is piggy-backed with an MIP extension. The MIP extension may simply comprise a particular value with a predetermined significance to the PDN gateway. In order to illustrate an example structural element that may operate as the PDN gateway, the GGSN 135 will be used in the following description.

On receiving the SA message from the MN 105, the PDN gateway 135 sets up 305 an SA with the MN 105 for a given lifetime Tₛₐ. In step 306, the PDN gateway 135 detects the SA extension or obtains from the SA extension an MIP message and forwards the obtained MIP message to the HA 144′.

The HA 144′ then receives the MIP message and updates 307 the MIP binding with the MN 105 over the SA for an MIP binding lifetime Tₘᵢₚ. The MIP binding lifetime Tₘᵢₚ may differ from the SA lifetime Tₛₐ. The HA 144′ (or in one embodiment the PDN gateway 135) also tears down 308 the previous connection by instructing the previous AP to release its connection with the MN 105.

The process illustrated in FIG. 3 may take place in various situations. It is anyway useful to notice that the process as any other process described in this document may be implemented in different order of steps and/or the operation within each step may differ from this disclosure, further steps may be included or some steps be omitted. To explain one case in which the process of FIG. 3 may take place, let us assume that the MN 105 first has an SA and MIP binding established to its cellular home network HA 144′ and that the MN 105 then starts roaming. The MN roams to the sub-network 104 and connects to an FA 142 in the first data network 140 via the sub-network 104 or alternatively roams to connect directly with the same or another FA 142 of the first data network 142. The MN 105 thus first has a first security association (SA) 155 drawn in FIG. 1 as a dotted line through the RAN 110 and the CN 120 to the HA 144 in the CN 120, before the MN 105 roams out of access to its home network (RAN 110).

On changing to use another access point, the first SA is left pending and the MN 105 starts establishing a second SA 160 drawn as a double line through its new access point and through an FA 142 in the first data network. The FA 142 in the first data network (e.g. the Internet) helps the MN 105 to form a second SA to the HA 144′ in the CN 120. The first SA 155 and the second SA 160 may be formed using the internet key exchange IKE and particularly (though not necessarily) with the IKE version 2 (IKEv2).

After the MN 105 has established a secure tunnel or the second SA 160 to the HA, the MN 105 may register a Binding Update (BU) to transfer its MIP connection through its new access point in the first data network 140. It should be noted at this connection that the FA has the task to facilitate in MIP connection processing related operations, but the actual communication using the MIP between the MN 105 and the HA 142′ takes place through varying routes via different routers between the MN 105 and the HA 142′. The security associations form a logical tunnel, not a physical one; the actual route of each packet exchanged between the MN 105 and the HA 142′ may vary and ordinary flow control measures such as those provided in the transport control protocol (TCP) may be applied to assemble different data packets into correct order and to ensure that missing packets are replaced using retransmissions if necessary.

On changing the SA with the HA 144′, the MN 105 may negotiate the second SA 160 and then exchange messages to register a binding update (BU) so as to bring the HA 144′ up to date as to the present whereabouts of the MN 105. This change may be important not only for maintaining accessibility of the MN 105 for external services and applications, but also for ensuring that charging for use of the RAN 110 would no longer run in case that time-based charging is applied (e.g. when roaming abroad the charging could result in a substantial invoice).

The MN 105 may also end up to a situation in which a life time of its MIP registration expires before or after its SA. It is recalled that the MIP registration or binding has a particular life term that is independent of the life term of the SA. While in particular foregoing examples both the SA and the MIP registration extend to the HA 144′, the SA may also be formed up to some other entity of the network in which the HA 144′ resides. For instance, the SA may be formed from the MN 105 to any Rendezvous Server (RVS) such as an outer gateway of the CN 120, for instance to the GGSN 135. In this case, the GGSN 135 may have no way of knowing the life time of the MIP registration and the HA 144′ could neither know of the second SA 160 as residing outside the SA formed logical tunnel.

It is appreciated that roaming from a network of one operator to a network of another operator provides merely one use case for describing some embodiments of the invention. Likewise, different example embodiments may be used in case of a hand-over within a common operator's network or between different networks of one operator (e.g. in case of travelling from one country or area to another while being attached or becoming attached to a network of a common operator.

An SA message with an MIP extension suited for use with different embodiments of the invention may involve any one or more of the following messages: a CP_CFG_BU (Configuration Payload, CP, Configuration CFG, binding update), CP_CFG_BA (Binding Acknowledgement), CP_CFG_BRI (binding revocation), or CP_CFG_BRA (Binding Revocation Acknowledgment).

In the foregoing, the operation of particular example embodiments of the invention have been described using a mobile node and a home agent or an intervening element such as a gateway of a core network as example parties or entities between which messages are exchanged. More generally, processes according to different embodiments of the invention may take place between two peers in a data communication system. Moreover, the term peer is not constrained to refer only to entities of similar type or function, but one entity may indeed be a small scale terminal client and the other a session in a vast server or farm of servers.

It is known that the IKEv2 employs a strict request/response message exchange scheme with responses (besides often also carrying information) always having the function of an acknowledgement. Thus the task of processing response messages falls solely on an initiator of an IKEv2 message exchange. An IKE_AUTH message exchange may not only authenticate the peers using pre-shared RSA public-key signatures or the extensible authentication protocol (EAP) but also may set up a first Security Association (SA) by defining traffic selectors (Traffic Selector for initiator, TSi/Traffic Selector of responder, TSr) and corresponding cryptographic transformations for the IPsec connection. In an embodiment of the invention, an MIP extension is appended to or piggy-backed to the IKEv2 request message.

It is also noted that at any time, either peer may send informational message which is always acknowledged by a response as mentioned above. An informational request may contain a notify (N), a delete SA (D) or a configuration payload (CP). Moreover, empty informational exchanges can be used to implement Dead Peer Detection (DPD). It is also appreciated that embedding of MIP related data to an SA related message may be applied to informational messages, and particularly though not exclusively to configuration payload messages.

An MIP related message may be sent on top of an SA message in various situations, some of which are listed in the following:
1. Secure tunnel establishment and HoA (Home Address) acquisition
2. Detecting when MN (Mobile Node) has moved into the trusted network
3. MN moving in or out from the trusted network
4. MN moving to an untrusted network
5. MN moving within enterprise network

Some further examples of the messages usable in example embodiments of the invention involve the additional configuration types, including value of CP to forward the binding updates/revocation including attributes type and relevant values for BU through IKEv2 messages. The following messages illustrate various additional mobility options (e.g. binding refresh request) that may be relevant to Mobile IP (V4 and/or V6) However for such options, there may be need to define particular types in IKE. Eventually such mobility options may be carried in secure manner over IKE messages.

For CP_CFG_(BU, BA, BRI, BRA) types the values may be selected between 128 and 255. These values are presently freely usable and any one of these values could be predetermined for indicating predetermined MIP related messages. By defining the meaning an MIP message correspondence for particular values, respective values may be used between different peers without prior negotiation of the use of such values. Alternatively, the peers may be configured to negotiate the associations between one or more SA extension values and respective MIP messages for future use.

The attributes types of BU include IPv6_ADDR_(HA, MN, CoA), lifetime with specific values and length may be pre-defined, see following examples:

IKE_AUTH exchange:

HDR, SK{MN_ID, [CERT,] [CERT_REQ,] [HA/PDN_ID,] AUTH, [CP(CFG_BU), SA, MN_TS, HA/PDN_TS]}, wherein SK is a shared key, ID is an identity, HDR is an ISAKMP header whose exchange type is the mode and ISAKMP stands for Internet Security Association and Key Management Protocol, CERT denotes a certificate, and TS stands for a time stamp.

HDR, SK{HA/PDN_ID, [CERT,] [CERT_REQ,] [MN_ID,] AUTH, [CP(CFG_BA), SA, HA/PDNTS, MN_TS]}

HDR, SK{MN_ID, [CERT,] [CERT_REQ,] [HA/PDN_ID, ] AUTH,[CP(CFG_BRI), SA, MN_TS, HA/PDN_TS]}

HDR, SK{HA/PDN_ID, [CERT,] [CERT_REQ, ] [MN_ID,] AUTH, [CP(CFG_BRA), SA, HA/PDNTS, MN_TS]}

Note last two exchange may be originated from either of the sites i.e. MN or HA/PDN, hence the relevant parameters will also get updated as from where it is initiated and responded respectively. Here only single example is given.

IKEv2 Informational message exchange:

HDR, SK{N(IPv6_Address), CP(CFG_BU/BRI)}

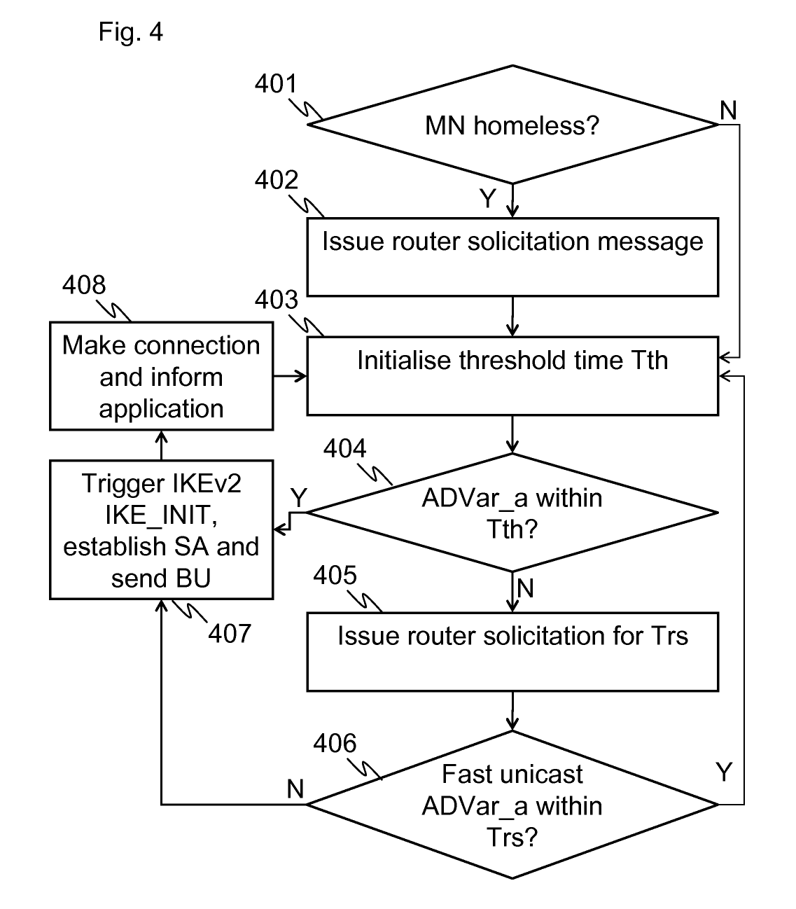

FIG. 4 illustrates a process for generating the second SA 160 according to an example embodiment of the invention. First, an application in the MN 105 needs access to the Internet and invokes an IP communication by accessing an IP communication interface, for example. The MN 105 then checks 401 whether homeless mode of operation (a form of MIP) is to be used. If yes, the MN 105 issues 402 a router solicitation message known from the MIP. If no, then the process continues to step 403.

In step 403, the MN 105 initializes a first threshold time Tth. Then, the MN checks 404 whether an advertising variable ADVar is within the first threshold time. If yes, the process jumps to step 407, otherwise a router solicitation message is issued for a second timer Trs. It is then checked whether a fast unicast ADVar_a has arrived within the second timer Trs associated with the router solicitation sent in step 405. If yes, the process resumes to step 403 to initialize the first threshold time Tth, otherwise the process continues to step 407 to trigger an IKEv2 with IKE_INIT message, to establish an SA and send a BU message on top of the SA establishment message. After step 407, a connection is made (step 408) and the MN 105 informs of the connection the application that has requested an IP access.

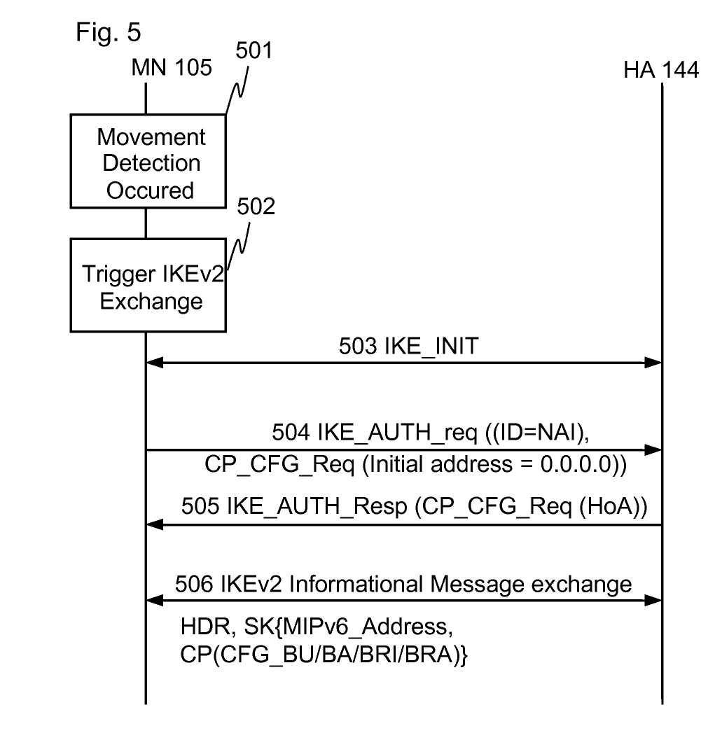

FIG. 5 shows an example of an IKEv2 exchange that may be used in the process of FIG. 4, particularly in connection with step 407 of FIG. 4. The exchange may take place after detecting movement of the MN 105 from one IP network to another (e.g. from a home network to a foreign network, from foreign network to home network, or between two different foreign networks). After detecting the movement, an IKEv2 message exchange 502 may be triggered. In the IKEv2 message exchange, an IKE initialization message IKE_INIT 503 may be sent from the MN 105 to the HA 144 or more generally to an IKEv2 peer. The MN 105 may then send an IKE authentication request message 504 with a network access identifier (NAI) set as an identity of the requestor, and a CP_CFG request with an initial address as 0.0.0.0. The peer may then reply with an IKE authorization message 505, IKE_AUTH_Resp which comprises the HoA of the MN 105. The MN 105 and its peer may perform an IKEv2 informational message exchange 506. The IKEv2 informational message exchange 506 may be used to exchange various types of configuration messages, such as the CFG_BU, CFG_BA, CFG_BRI or CFG_BRA (explained in connection with FIG. 3).

Particular example embodiments of the invention are next illustrated by reference to major structural and functional elements thereof. In some embodiments, timely triggering of IKEv2 exchange to establish secure security association (SA) may be achieved using a detection algorithm such as consistent cell switching (CCS). Moreover, further IKEv2 related messages may be enhanced to account for mobility events such as binding registration or revocation. Hence, some dedicated MIP related separate messages may be avoided.

Assuming that through IKE negotiation, the MN 105 acquires a Home Address (HoA i.e. a CoA at the HA) and performs the initial registration with Home agent. However when an end device is away from home network, the end device should send a binding update to the HA.

It is appreciated that particular example embodiments of the invention may enable timely handover and binding update/revocation in secure manner. Different embodiments may also operable in an I-WLAN/non-3GPP mobility standardization where UE needs to enable a Hello_init (HI) attach procedure with an HA or dynamic HA to create the IKEv2 based SA.

Moreover, different embodiments of the invention may further or alternatively provide any of the following advantages:
reduce signalling relevant to MIPv6 on a hand-over or MIP binding renewal
enable binding the lifetime of an SA/IKEv2 with the lifetime of a Binding update or revocation and/or enable simple control of the exchange of related signaling messages
remove or at least mitigate the need the additional child SA requirements for MIP signaling
facilitate multiple binding updates or revocations making use of IKEv2 support for Multihoming

NOTE: In this document, the CP_CFG_Req and CP_CFG_Resp in IKE_AUTH messages represent generic text and may be replaced with other types such as CP_CFG_BA/BRI and CP_CFG_BU/BRA respectively as presented in IKEv2 information message exchange. Also note that unlike binding update/acknowledgement, binding revocation and acknowledgment messages can be originated either from MN or HA/PDN.

Further or alternatively, a particular data field in an SA registration message is employed to convey MIP related piggy-backed messages to the HA 142′. Such piggy-backed MIP related messages are conveyed on top of necessary SA registration messages up to the end-point of the second SA 160 and then relayed by the end-point of the second SA 160 (e.g. by the GGSN 135) to the HA 144′. Such an embodiment may avoid or reduce the need for transferring messages between the MN 105 and the network of the HA 144′. Thus, hand-over processes and particularly inter-system handovers may be accelerated and radio resource consumption be reduced on the leg between the MN 105 and the AP 143 through which the MN 105 connects to the FA 142.

The foregoing description has provided by way of non-limiting examples of particular implementations and example embodiments of the invention a full and informative description of the best mode presently contemplated by the inventors for carrying out the invention. It is however clear to a person skilled in the art that the invention is not restricted to details of the example embodiments presented above, but that it can be implemented in other embodiments using equivalent means or in different combinations of embodiments without deviating from the characteristics of the invention.

Furthermore, some of the features of the above-disclosed example embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1.-30. (canceled)

31. A method comprising:
preparing an internet key exchange security association message, using a processor;
containing in the security association message an extension indicative of a mobile internet protocol binding related instruction to a home agent; and
sending the security association message to a packet data network.

32. A method according to claim 31, wherein the method is performed by a mobile node.

33. A method according to claim 3Error! Reference source not found, wherein the method further comprises:
communicating by the mobile node through a first packet data network;
changing to communicate by the mobile node through a second packet data network and
responsively performing the preparing of the internet key exchange security association message.

34. A method according to claim 332, further comprising establishing a security association between a mobile node and an intervening network element.

35. A method according to claim 31, wherein the security association has a lifetime for which the security association is operable and the method further comprises maintaining a timer associated with the lifetime and preparing the internet key exchange security association message automatically responsively to the timer indicating that the lifetime is at its end.

36. A method according to claim 31, wherein the method is performed by a mobile node and the method further comprises:
establishing a mobile internet protocol binding between the mobile node and the home agent; and
controlling the home agent in relation to the mobile internet protocol binding with the security association message comprising the extension.

37. A method according to claim 31, wherein the extension comprises a predetermined value attached to an informative data field of the internet key exchange security association message.

38. A method according to claim 31, wherein the mobile internet protocol binding related instruction is configured to define one of the following messages: a binding update; a binding acknowledgement; binding revocation; and a binding revocation acknowledgment.

39. An apparatus comprising a memory configured to store instructions and a processor configured to perform according to the instructions:
prepare an internet key exchange security association message;
contain in the security association message an extension indicative of a mobile internet protocol binding related instruction to a home agent; and
send the security association message to a packet data network.

40. An apparatus according to claim 339, wherein the apparatus is a mobile node.

41. An apparatus according to claim 39, wherein the processor is further configured to:
cause the apparatus to communicate through a first packet data network;
cause the apparatus to change to communicate through a second packet data network and responsively to perform the preparing of the internet key exchange security association message.

42. An apparatus according to claim 39, the processor being further configured to establish a security association between the apparatus and an intervening network element.

43. An apparatus according to claim 39, wherein the security association has a lifetime for which the security association is operable and the processor being further configured to maintain a timer associated with the lifetime and to prepare the internet key exchange security association message automatically responsively to the timer indicating that the lifetime is at its end.

44. An apparatus according to claim 39, the processor being further configured to:
establish a mobile internet protocol binding between the apparatus and the home agent; and
control the home agent in relation to the mobile internet protocol binding with the security association message comprising the extension.

45. An apparatus according to claim 39, wherein the extension comprises a predetermined value attached to an informative data field of the internet key exchange security association message.

46. An apparatus according to claim 39, wherein the mobile internet protocol binding related instruction is configured to define one of the following messages: a binding update; a binding acknowledgement; binding revocation; and a binding revocation acknowledgment.

47. An apparatus comprising a memory configured to store instructions and a processor configured to perform according to the instructions:
receive from a mobile internet protocol mobile node an internet key exchange security association message;
determine in the security association message a mobile internet protocol binding related instruction to a home agent of the mobile node;
store a mobile internet protocol message based on the determined mobile internet protocol related instruction; and
send the mobile internet protocol message to the home agent of the mobile node.

48. A computer readable memory medium comprising computer executable program code for causing an apparatus when processing the program code to:
prepare an internet key exchange security association message;
contain in the security association message an extension indicative of a mobile internet protocol binding related instruction to a home agent; and
send the security association message to a packet data network.
